(19) United States
(12) Patent Application Publication
(10) Pub. No.: US 2026/0212275 A1
(43) Pub. Date: Jul. 23, 2026

(54) Real-Time Context Management for Artificial-Intelligence-Enabled Assistant

(71) Applicant: Blue Yonder Defense Solutions, LLC, Dallas, TX (US)

(72) Inventors: Ranjit Notani, Plano, TX (US); Nageen Athmuri, Flower Mound, TX (US)

(21) Appl. No.: 19/456,366

(22) Filed: Jan. 22, 2026

Related U.S. Application Data
(60) Provisional application No. 63/748,219, filed on Jan. 22, 2025.
(60) Provisional application No. 63/859,842, filed on Aug. 7, 2025.

(51) Int. Cl. G06N 20/00; G06Q 10/087

(52) U.S. Cl. CPC G06N 20/00; G06Q 10/0877

(57) ABSTRACT

A system includes memory hardware storing a defined data structure that specifies a plurality of groups associated with a set of users, schedule data, and relationship data. The system includes a context module configured to determine a default context associated with a first user. The first user is included in a respective set of users of a first group of a plurality of groups. The default context is associated with a subset of the schedule data, a subset of the plurality of groups, and the respective set of users. The system includes a real-time state module configured to determine a first real-time state of the defined data structure. The system includes an action generation module configured to, in response to a determination that an issue exists in the first real-time state of the defined data structure, generate and execute a set of solutions for the issue.

### CROSS-REFERENCE TO RELATED APPLICATIONS

This application claims the benefit of U.S. Provisional Application No. 63/859,842 filed Aug. 7, 2025 (Attorney Docket No. 59708-5), and U.S. Provisional Application No. 63/748,219 filed Jan. 22, 2025 (Attorney Docket No. 59708-3). The entire disclosures of the above applications are incorporated by reference.

### FIELD

The present disclosure is generally related to machine learning models and, more particularly, to managing model context to improve computational efficiency of machine learning models.

### BACKGROUND

Managing and optimizing complex supply chains often includes managing large quantities of data with complex relationships and interdependencies. Machine learning models, while a valuable tool for data management and analysis, often cannot accurately manage data that changes in real-time. Therefore, a solution is required to manage constantly updated data via machine learning models.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system includes memory hardware storing a defined data structure that specifies a plurality of groups that is each associated with a respective set of users, schedule data, and relationship data that describes relationships between the plurality of groups, each respective set of users, and the schedule data. The system includes a context module configured to determine a default context associated with a first user. The first user is included in a respective set of users of a first group of the plurality of groups. The default context is associated with a subset of the schedule data, a subset of the plurality of groups, and the respective set of users. The system includes a user interface module configured to receive and transmit user input and transmit data to the first user. The system includes a machine learning model interface module configured to generate prompts for a machine learning module based on user input from the user interface module and receive textual output from the machine learning module. The system includes a real-time state module configured to determine, via a machine learning model, a first real-time state of the defined data structure. The first real-time state is based on the default context. The system includes a real-time state module configured to determine, via the machine learning model, whether an issue exists in the first real-time state of the defined data structure. The system includes an action generation module configured to, in response to a determination that an issue exists in the first real-time state of the defined data structure, generate, via the machine learning model, a set of solutions for the issue. The set of solutions is based on the first real-time state of the defined data structure. The system includes an action generation module configured to, in response to a user input associated with a selection of a solution of the set of solutions, execute the selected solution. The real-time state module is configured to, in response to the execution of the selected solution, replace the first real-time state of the defined data structure with a second real-time state of the defined data structure based on the default context and the selected solution. The system includes an inference module configured to generate, via the machine learning model, a secondary response to user input based on the first real-time state or the second real-time state.

In other features, the subset of the schedule data, the subset of the plurality of groups, and the respective set of users is selected based on the relationship data. In other features, the default context is based on one or more secondary sets of users associated with the subset of the plurality of groups.

In other features, inferring whether to generate the secondary response is based on a secondary prompt to the machine learning model. In other features, the secondary prompt is based on the user input. In other features, the secondary response includes a visualization of a portion of the first real-time state or the second real-time state. In other features, replacing the first real-time state includes marking the first real-time state of the defined data structure as historical data.

In other features, the system includes a prompt generation module configured to generate a set of prompts based on the default context. The set of prompts is based on a set of previous user inputs from the first user, a set of inputs from a set of secondary users, and a set of responses with a high effectiveness score.

In other features, the context module is configured to determine a set of contexts associated with the first user. In other features, the default context is included in the set of contexts. In other features, the user interface module is configured to receive a first user input, and in response to receiving the first user input, generate a link to use a second context from the set of contexts.

In other features, the system includes a function library configured to store a set of functions. A first function of the set of functions includes a set of sample queries. In other features, the system includes a similarity module. The similarity module is configured to, in response to receiving a set of queries, determine a similarity metric based on a comparison of the set of queries and the set of sample queries. The similarity module is configured to, in response to a determination that the similarity metric meets a similarity threshold, add the first function to a set of down-selected functions. In other features, the system includes a large language model (LLM) module. The LLM module is configured to determine, using an LLM, one or more functions of the set of down-selected functions to execute. The LLM module is configured to receive a set of function responses corresponding to the one or more functions of the set of down-selected functions. The LLM module is configured to determine, using the LLM, a response to the set of queries based on the set of function responses. In other features, the system includes a function handler module configured to execute the one or more functions of the set of down-selected functions. In other features, the one or more functions traverse a data graph. In other features, the one or more functions select a set of sub-graphs of the data graph. In other features, the one or more functions translate the set of sub-graphs into the set of function responses. In other features, translating the set of sub-graphs into the set of function responses includes generating a set of narrative text describing a set of relationships of the set of sub-graphs. In other features, the set of narrative text includes a set of viewpoints.

In other features, a first viewpoint of the set of viewpoints includes a subset of the set of narrative text based on a first filter of a set of filters. In other features, the set of sample queries includes queries that can be answered with the set of sub-graphs selected by the first function. In other features, the comparison of the set of queries and the set of sample queries includes performing cosine similarity of the set of queries and at least one sample query of the set of sample queries. In other features, the set of narrative text includes a set of plain-text strings that describes the set of sub-graphs. In other features, the LLM module is configured to communicate with the LLM via an application programming interface (API).

In other features, the set of filters includes at least one of a filter associated with a destination location, a filter associated with a source location, a filter associated with a carrier, a filter associated with a time, a filter associated with a region, a filter associated with a transportation type, or a filter associated with a delivery status.

In other features, the system includes a query orchestrator module. The query orchestrator module is configured to determine whether a context associated with the set of queries exceeds a token limit associated with the LLM. The query orchestrator module is configured to, in response to a determination that the context exceeds the token limit, transmit a query to the similarity module to determine the set of down-selected functions, and transmit the query to the LLM module.

In other features, the similarity threshold is determined based on at least one of, whether one of the set of sample queries is used to determine the similarity metric, or whether the set of sample queries is concatenated into a single string and used to determine the similarity metric.

A method includes determining a default context associated with a first user. The defined data structure specifies a plurality of groups that is each associated with a respective set of users, schedule data, and relationship data that describes relationships between the plurality of groups, each respective set of users, and the schedule data. The first user is included in a respective set of users of a first group of the plurality of groups. The default context is associated with a subset of the schedule data, a subset of the plurality of groups, and the respective set of users. The method includes receiving and transmitting user input. The method includes transmitting data to the first user. The method includes generating prompts for a machine learning module based on user input. The method includes receiving textual output from the machine learning module. The method includes determining, via a machine learning model, a first real-time state of the defined data structure. The first real-time state is based on the default context. The method includes determining, via the machine learning model, whether an issue exists in the first real-time state of the defined data structure. The method includes, in response to a determination that an issue exists in the first real-time state of the defined data structure, generating, via the machine learning model, a set of solutions for the issue. The set of solutions is based on the first real-time state of the defined data structure. The method includes, in response to a user input associated with a selection of a solution of the set of solutions, executing the selected solution. The method includes, in response to the execution of the selected solution, replacing the first real-time state of the defined data structure with a second real-time state of the defined data structure based on the default context and the selected solution. The method includes generating, via the machine learning model, a secondary response to user input based on the first real-time state or the second real-time state.

In other features, inferring whether to generate the secondary response is based on a secondary prompt to the machine learning model. In other features, the secondary prompt is based on the user input. In other features, the secondary response includes a visualization of a portion of the first real-time state or the second real-time state. In other features, replacing the first real-time state includes marking the first real-time state of the defined data structure as historical data.

In other features, the method includes determining a set of contexts associated with the first user. The default context is included in the set of contexts. In other features, the method includes receiving a first user input. In other features, the method includes, in response to receiving the first user input, generating a link to use a second context from the set of contexts.

In other features, the method includes storing a set of functions. A first function of the set of functions includes a set of sample queries. In other features, the method includes, in response to receiving a set of queries, determining a similarity metric based on a comparison of the set of queries and the set of sample queries. In other features, the method includes, in response to a determination that the similarity metric meets a similarity threshold, adding the first function to a set of down-selected functions. In other features, the method includes determining, using an LLM, one or more functions of the set of down-selected functions to execute. In other features, the method includes receiving a set of function responses corresponding to the one or more functions of the set of down-selected functions. In other features, the method includes determining, using the LLM, a response to the set of queries based on the set of function responses. In other features, the method includes executing the one or more functions of the set of down-selected functions. In other features, the one or more functions traverse a data graph. In other features, the one or more functions select a set of sub-graphs of the data graph. In other features, the one or more functions translate the set of sub-graphs into the set of function responses. In other features, translating the set of sub-graphs into the set of function responses includes generating a set of narrative text describing a set of relationships of the set of sub-graphs. In other features, the set of narrative text includes a set of viewpoints.

In other features, a first viewpoint of the set of viewpoints includes a subset of the set of narrative text based on a first filter of a set of filters. In other features, the set of sample queries includes queries that can be answered with the set of sub-graphs selected by the first function. In other features, the comparison of the set of queries and the set of sample queries includes performing cosine similarity of the set of queries and at least one sample query of the set of sample queries. In other features, the set of narrative text includes a set of plain-text strings that describes the set of sub-graphs.

A non-transitory computer-readable storage medium includes processor-executable instructions. The instructions include determining a default context associated with a first user. The defined data structure specifies a plurality of groups that is each associated with a respective set of users, schedule data, and relationship data that describes relationships between the plurality of groups, each respective set of users, and the schedule data. The first user is included in a respective set of users of a first group of the plurality of groups. The default context is associated with a subset of the schedule data, a subset of the plurality of groups, and the respective set of users. The instructions include receiving and transmitting user input. The instructions include transmitting data to the first user. The instructions include generating prompts for a machine learning module based on user input. The instructions include receiving textual output from the machine learning module. The instructions include determining, via a machine learning model, a first real-time state of the defined data structure. The first real-time state is based on the default context. The instructions include determining, via the machine learning model, whether an issue exists in the first real-time state of the defined data structure. The instructions include, in response to a determination that an issue exists in the first real-time state of the defined data structure, generating, via the machine learning model, a set of solutions for the issue. The set of solutions is based on the first real-time state of the defined data structure. The instructions include, in response to a user input associated with a selection of a solution of the set of solutions, executing the selected solution. The instructions include, in response to the execution of the selected solution, replacing the first real-time state of the defined data structure with a second real-time state of the defined data structure based on the default context and the selected solution. The instructions include generating, via the machine learning model, a secondary response to user input based on the first real-time state or the second real-time state.

In other features, inferring whether to generate the secondary response is based on a secondary prompt to the machine learning model. In other features, the secondary prompt is based on the user input. In other features, the secondary response includes a visualization of a portion of the first real-time state or the second real-time state. In other features, replacing the first real-time state includes marking the first real-time state of the defined data structure as historical data.

In other features, the instructions include determining a set of contexts associated with the first user. In other features, the default context is included in the set of contexts. In other features, the instructions include receiving a first user input. In other features, the instructions include, in response to receiving the first user input, generating a link to use a second context from the set of contexts.

In other features, the instructions include storing a set of functions. In other features, a first function of the set of functions includes a set of sample queries. In other features, the instructions include, in response to receiving a set of queries, determining a similarity metric based on a comparison of the set of queries and the set of sample queries. In other features, the instructions include, in response to a determination that the similarity metric meets a similarity threshold, adding the first function to a set of down-selected functions. In other features, the instructions include determining, using an LLM, one or more functions of the set of down-selected functions to execute. In other features, the instructions include receiving a set of function responses corresponding to the one or more functions of the set of down-selected functions. In other features, the instructions include determining, using the LLM, a response to the set of queries based on the set of function responses. In other features, the instructions include executing the one or more functions of the set of down-selected functions. In other features, the one or more functions traverse a data graph. In other features, the one or more functions select a set of sub-graphs of the data graph. In other features, the one or more functions translate the set of sub-graphs into the set of function responses. In other features, translating the set of sub-graphs into the set of function responses includes generating a set of narrative text describing a set of relationships of the set of sub-graphs. In other features, the set of narrative text includes a set of viewpoints.

In other features, a first viewpoint of the set of viewpoints includes a subset of the set of narrative text based on a first filter of a set of filters. In other features, the set of sample queries includes queries that can be answered with the set of sub-graphs selected by the first function. In other features, the comparison of the set of queries and the set of sample queries includes performing cosine similarity of the set of queries and at least one sample query of the set of sample queries. In other features, the set of narrative text includes a set of plain-text strings that describes the set of sub-graphs.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a block diagram of an example real-time context during an interaction with an artificial-intelligence-enabled (“AI-enabled”) assistant.

FIG. 2 is a block diagram of example real-time contexts used by an AI-enabled assistant.

FIG. 3 is a block diagram of an example method for recontextualizing outdated context in an interaction with an AI-enabled assistant.

FIG. 4 is a block diagram of an example method for redacting outdated context from an interaction with an AI-enabled assistant.

FIG. 5 is a block diagram of an example interaction process with an AI-enabled assistant.

FIGS. 6A and 6B are illustrations of example user interfaces for interacting with an AI-enabled assistant according to the principles of the present disclosure.

FIGS. 7-19 are illustrations of example user interfaces for interacting with an AI-enabled assistant according to the principles of the present disclosure.

FIGS. 20A-20B are a flowchart of an example method for creating LLM-understandable context based on large real-time datasets.

FIG. 21 is a functional block diagram of an example system for creating LLM-understandable context based on large real-time datasets.

In the drawings, reference numbers may be reused to identify similar and/or identical elements.

### DETAILED DESCRIPTION

### Introduction

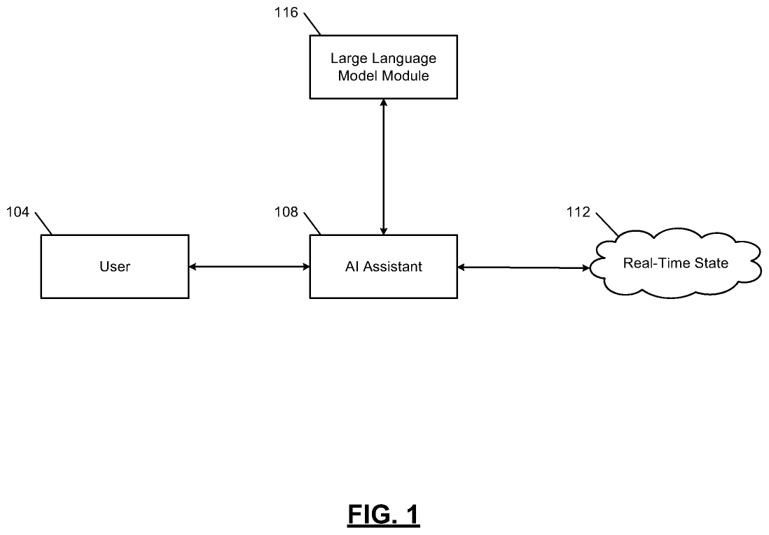

According to various embodiments, the present invention includes an artificial-intelligence-enabled (“AI-enabled”) assistant (for example, an AI assistant 108 as shown in FIG. 1) with a natural language chat interface that assists supply chain users (for example, user 104) in analysis, visualization, decision making, and a network specified by problem solving in real-time multi-enterprise supply chain networks (for example, real-time state 112). In various embodiments, the network is represented as a defined data structure, such as a graph. In various embodiments, the assistant includes, without limitation: (i) an adaptive problem-solving module (for example, large language model module 116); (ii) a permission module; and (iii) a real-time interactive visualization module. In various embodiments, AI assistant 108 includes a user interface module for receiving input from user 104 and displaying visualizations, analysis, and answers.

In various embodiments, AI assistant 108 includes an AI agent. In various embodiments, AI assistant 108 gathers context from real-time state 112. In various embodiments, AI assistant 108 uses LLM module 116 to analyze the context from real-time state 112 to answer queries (or perform actions) from user 104. In various embodiments, AI assistant 108 transmits a context subnet (in other words, a portion) of real-time state 112 to LLM module 116 for analysis. In various embodiments, a subnet is analyzed (instead of the full real-time state) to improve processing efficiency.

In various embodiments, context from real-time state 112 is gathered periodically (such as by a polling function every 5, 30, or 60 seconds). In various embodiments, AI assistant 108 receives an update to a specific context subnet when a change to the specific context subset occurs. In various embodiments, a context subnet has one or more types, such as a geographic area or geo-lane. In various embodiments, a subnet includes geo-lane properties such as traffic, weather, positions of shipments, etc.

The adaptive problem-solving module guides users by suggesting executable prescriptions (also called actions or solutions) based on the current real-time state of the supply chain, which in turn is a function of other parties' actions as well as the AI assistant's own actions (in other words, actions performed by the AI assistant based on instructions from the user 104). In various embodiments, the real-time state of the supply chain is reflected consistently across the entire supply chain network within seconds. In various embodiments, a supply chain network includes a graph of all entities, transactions, relationships, shipments, and/or data permissions of entities (such as which entity has permission to modify routes, priorities, or delivery times).

The permission module subjects AI assistant actions to the permissibility of the supply chain network. For example, if the user does not have permission to modify an order, then the AI assistant will inherit and be subject to that same permission.

The real-time interactive visualization module generates and displays real-time interactive visualizations that may be relevant to the user even if the user has not asked for them directly. The real-time interactive visualizations are generated by the AI assistant via a machine learning model based on the real-time state of the supply chain.

In various embodiments, each user or role may have their own assistant. In various embodiments, assistants and humans are organized into a supply chain agentic network. In various embodiments, assistants often share the same (or similar) functions but are configured to be role-specific. For example, the details for a buyer-planner assistant will generally be different from those of a transportation manager assistant. In various embodiments, assistants can automatically collaborate with other assistants for additional problem solving.

In various embodiments, an assistant is embedded into a broader application. In this case, visualizations, commands, and prescriptions may have hyperlink connections (such as to the corresponding screen or page in the application).

In various embodiments, the present disclosure improves the efficiency (such as memory usage and computational requirements) and accuracy of large language model operation by limiting analysis to specific contexts defined by user roles.

### Large Language Models

The supply chain assistant of the present invention leverages one or more machine learning models, such as a large language model (LLM), for the various language reasoning tasks described herein. A user may interact with an assistant of the present invention using, for example, keyboard, mouse, touchscreen display, gestures, text, text-to-speech, and/or speech-to-text.

In various embodiments, the AI-enabled assistant uses an LLM as a supporting function via an LLM-adaptor layer rather than the user directly interacting with the LLM. Instead, the AI-enabled assistant mediates this interaction. As used herein, an “AI-enabled assistant” or sometimes “assistant,” is an entity that the user converses with and that carries out actions on behalf of the user. In various embodiments, the AI-enabled assistant interacts with the LLM via a prompt sent to the LLM in the form of text, which can be described as response=llm(prompt).

The prompt may be composed of sub-parts and the term “full prompt” is used to denote all the parts included in a prompt (for example, a full prompt may include a concatenation of parts 1-3). In the present disclosure, “+” implies text concatenation. As used herein, the suffix “-llmready” denotes serializing information into a textual form suitable for interpretation by the LLM. For example, “xyz-llmready” is a serialized textual form of “xyz.” In general, this is accomplished by a serialize-to-llm-ready transform, such as xyz-llmready=serialize-to-llm-ready(xyz).

### Assistant Context

In various embodiments, each user or role has their own assistant. In various embodiments, each assistant is partitioned into contexts, which are similar to topics and allow users to interact with the AI assistant within a specific environment or set of information. For example, a context may be limited to information related to a specific shipment, information the user has access to, information related to a particular enterprise, etc. In various embodiments, using multiple contexts facilitates minimizing context size when interacting with LLMs, which often have context length limitations. Contexts are tied to “subnets” of a supply chain network. Subnets are multi-dimensional slices of the supply chain network. For example, a subnet may be, without limitation, an item, an order, a plan, or other supply chain element. In various embodiments, a context includes a user's role at a company, a user's relationship to shipments, a user's relationship to other users, and/or a single shipment. In various embodiments, each assistant has knowledge and comprehension over all of the contexts the AI assistant operates over. In various embodiments, the contexts account for the value chain permissions that the user has relative to the subnets. When responding to a user in a given context, the AI assistant can route the user to an appropriate alternate context. In various embodiments, the routing is explicitly invoked by the user or implicitly by the assistant. In various embodiments, the context includes the role of the user.

Each AI-enabled assistant can support one or more contexts. Each context is associated with some subnet of the overall supply chain. Each context has an associated real-time-state that can be retrieved. As used herein, a “context-real-time-state-llmready” is a current context-real-time-state converted to an LLM-ready form. Converting the context-real-time state includes serializing the context-real-time-state into an appropriate textual form that is understandable by an LLM.

Each assistant has a governing user, which is typically a human. In various embodiments, the AI assistant acts as its own governing user and becomes fully agentic. The term “user” as used herein describes the governing user. Each user can have one or more governed assistants (in other words, multiple assistants can have the same governing user). In various embodiments, a user has a default assistant. In various embodiments, each assistant has one or more personas. The persona represents the capabilities, permissions, tone, etc. that the AI assistant presents to the user. In various embodiments, an assistant includes a default (or primary) persona and one or more secondary personas.

### Real-Time State

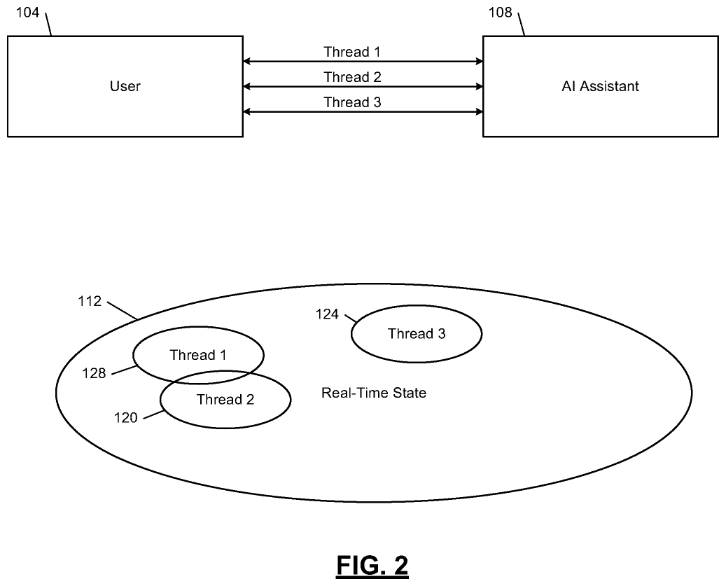

Each context of an assistant includes a thread of conversation between the governing user and the AI assistant. The context conversation thread is based on a series of messages sent between the governing user and assistant. Additionally, in various embodiments, the AI assistant handles the changing real-time state of the supply chain, such as various shipments, which can change over the course of the conversation. In various embodiments, an assistant maintains a conversation history and context for longer than a single communication session. For example, a conversation history (and therefore context) may span days, weeks, or months and multiple interaction sessions. As a user interacts with the AI assistant in a particular context, the status of shipments (and therefore the real-time context) will change. As one example, in FIG. 2, three threads exist between user 104 and AI assistant 108. Thread 128, thread 120, and thread 124 create various context-dependent real-time states within real-time state 112. As shown in FIG. 2, contexts can overlap in various embodiments.

In various embodiments, the AI assistant is embedded in a real-time supply chain network where there are other AI assistants, other users, other companies, autonomous bots, etc. All of these, as well as the AI assistant's or user's own actions, change the state that the AI assistant is considering. In various embodiments, each assistant deals with one or more real-time contexts, such as some part of the real-time supply chain. The context is a function of the role of the AI assistant's governing user. As an example, a logistics planner user dealing with five geo-lanes has an assistant that deals with the same geo-lanes. In various embodiments, the AI assistant may further divide the user's context into several real-time contexts. For example, the AI assistant may divide the five geo-lanes into separate contexts that each contain a geo-lane. A geo-lane is an optimized route used for moving goods across different geographic regions. For example, a geo-lane may include a highway or series of interconnected roads that are commonly used by freight carriers, ensuring efficiency in delivery.

### Historical Context

Handling the real-time changing state in a multi-user, multi-agent, multi-assistant, multi-enterprise supply chain for an AI assistant presents challenges because of the contradictions inherent with reconciling the current state with the conversation history (and therefore outdated states). In various embodiments, the latest state includes the location of shipments, transport locations, and/or schedule data (such as estimated arrival dates, etc.). The historical context of the conversation between the governing user and the AI assistant allows the AI assistant to consider the previous interactions in generating responses. Without the historical context, the LLM treats each message in the conversation independently of the previous message. In other words, without the historical context, the conversation would be a series of independent messages rather than a coherent thread of conversation.

As the governing user is interacting with the AI assistant, the AI assistant detects problems (associated with and limited to the user's contexts) in real-time. Typically, LLM chatbots are given context data (such as a prompt) that is used to produce a response. The prompt is typically auto-regressive (in other words, the prompt contains the entire conversation history up to that point). However, in the context of continuous real-time change, the history can be factually misleading. A traditional approach may include sending the context real-time state of the supply chain, the user-perceived history (in other words, the chat history between the user and the AI assistant, such as questions, answers, actions taken, and/or older state versions), and the user's incremental prompt to the LLM.

For example, a traditional prompt includes full prompt=context-real-time-state-llmready+user-perceived-history+user-incremental-prompt. As used herein, a “context-real-time-state-llmready” is a current context real-time-state converted to an LLM-ready form. However, the real-time state and user-perceived history will, in the general case, be contradictory due to the changing real-time state. For example, the real-time context state at the beginning and end of a conversation will be different if the user revises a delivery time of a shipment. As another example, at the start of a conversation about a shipment the shipment was on time. However, at a later point, due to external factors (like a delayed truck), the shipment is now delayed. To the AI assistant, the total history contains contradictory information (that the shipment is both on time and delayed).

There are several options to resolve the historical context contradiction. One option is to exclude the history when sending the next prompt. However, the context is lost, and this leads to a disjointed series of independent messages rather than a continued thread of conversation. In other words, it causes the AI assistant to “forget” previous prompts in the conversation.

The present disclosure describes an alternative approach: computing a state with recontextualized history. In other words, instead of a traditional prompt as described above, a “real-time” full prompt is sent including the recontextualized history and the user incremental prompt. For example, the alternative prompt includes real-time full prompt=state-with-recontextualized-history+user-incremental-prompt.

### Recontextualized History: Meta-Cognitive Approach

There are various ways to produce the state-with-recontextualized-history. In various embodiments, this is accomplished by a meta-cognitive approach in which the LLM is provided with context details. In various embodiments, the meta-cognitive approach includes the AI assistant instructing the LLM (such as LLM module 116) with meta-cognitive instructions to prioritize the current context over historical context. In other words, both historical and current contexts are passed to the LLM and the LLM is instructed how to resolve conflicts. In various embodiments, the meta-cognitive approach requires an LLM with strong meta-cognition (in other words, an LLM with a strong understanding of historical and current information and the ability to understand instructions on how to resolve conflicts between the two contexts).

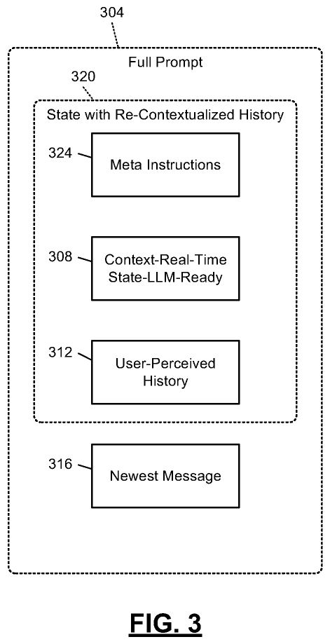

FIG. 3 is an example of a full prompt using a meta-cognitive approach. In various embodiments, the meta-cognitive approach includes providing the LLM with meta-cognitive instructions and context details such as:
a) Informing the LLM that it is participating in a chat with a user on a topic (for example, the chat includes newest message 316);
b) The topic has a state that is potentially changing;
c) A user-perceived history (in other words, the chat history between the AI Assistant and user, including questions, answers, and actions) is being passed to the LLM (for example, user-perceived history 312);
d) At each point in the user-perceived history, the state may have been different;
e) The user-perceived history may contain facts that contradict the current state (for example, context-real-time-state-llmready 308);
f) When answering the full prompt (for example, full prompt 304), the LLM should attempt to use as much of the user-perceived history (the history of the conversation as perceived by the user) as possible;
g) If the user-perceived history contradicts the real-time state, the real-time state takes precedence; and

h) Prompting the LLM with the latest message from the user (such as newest message 316).

Therefore, the state-with-recontextualized-history (320)=meta-cognitive-instructions (324)+user-perceived-history (312)+context-real-time-state-llmready (308). The full prompt=state-with-recontextualized-history+newest message.

In various embodiments, LLM module 116 includes multiple LLMs. For example, LLM module 116 may include an LLM for determining a difference between a current context (context-real-time-state-llmready) and a historical context (such as included in user-perceived-history or meta-cognitive-instructions). In various embodiments, a difference between current and historical contexts is determined via a function and transmitted to the LLM.

### Recontextualized History: Redacted History

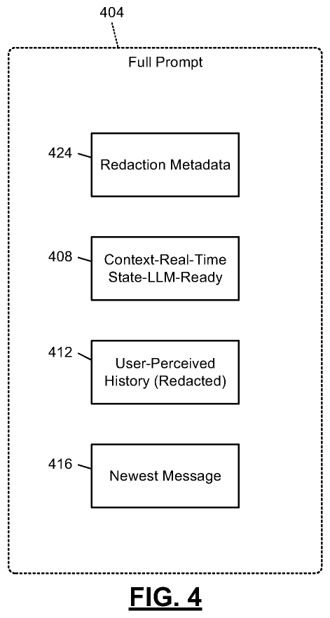

In various embodiments, instead of using a meta-cognitive approach for recontextualizing the user-perceived history, a redaction approach is used. FIG. 4 is an example of a redaction prompt. In the redacted history approach, two calls are made to the LLM. First, a call is made to the LLM and the user-perceived-history (such as 412) and context-real-time-state-llmready (such as 408) are passed to the LLM. With the first call, the LLM is instructed (for example, in redaction metadata 424) to list out historical messages that contradict the current real-time state. The contradictory messages are then redacted. In the second call, the LLM is used to answer a query from newest message 416 based on the context-real-time-state-llmready and the redacted-user-perceived-history.

For example, the interaction with the LLM includes:
Step 1: Instruct the LLM to retrieve contradictory messages (redaction metadata 424), where contradictory messages=llm(user-perceived-history, context-ready-real-time-state);
Step 2: Construct the redacted-user-perceived-history by removing contradictory messages (in other words, historical data that contradicts the current real-time state); and
Step 3: Send the full-prompt (404)=context-real-time-state-llmready+redacted-user-perceived-history (412)+newest message (for example, 416).

### Context Switching and Linking

In various embodiments, an assistant has more than one context, which allows coherent threads of discussion. This also allows the real-time-state to be loaded and cached at the start of each interaction (so that the user is not required to re-enter the context information on every message). In various embodiments, instead of multiple explicit contexts, an implicit context is determined based on the user's message.

In various embodiments, the user can switch contexts manually, via a user interface. Whenever the AI assistant references another context, it will also produce a context switch link. This context switch link is like a hyperlink between contexts. The user can choose to select that context link to switch contexts. The AI assistant determines whether a context link is appropriate by analyzing its own output in a side query. Analyzing the output includes: a) asking the LLM if the output maps to a list of well-known context types; b) if yes, the AI assistant asks the LLM to extract the context information from the output; c) the AI assistant then iterates over all contexts to see if any match the output; and d) if yes, then the AI assistant creates and shows the link to the related context. In various embodiments, the user can set a policy to auto-switch to a new context when the AI assistant recommends switching contexts. In various embodiments, context switching allows the user to seamlessly work over much larger context sizes than would otherwise be permissible by an LLM. This differs from Retrieval Augmented Generation (RAG), in that RAG does not provide any provision for seamless multi-context switching or inherently dealing with multi-context real-time state over a supply chain.

### Problem Detection

To enable adaptive problem solving, the AI assistant must detect problems. The problem definitions can be either pre-defined or learned. Pre-defined problem types are defined for each context available to the AI assistant. The supply chain network exposes a standard API for retrieving instances of problems for these problem types.

Learned problem types are problem types that are learned over time by the AI assistant. This is accomplished in several steps. First, the AI assistant retrieves the state associated with the context. Second, the AI assistant reviews the context to detect problems. Third, the AI assistant generates problem-detection prompt (which is used to detect the problem) and the learned-problem-type prompt. The AI assistant then transmits these prompts to the LLM. Using the LLM's analysis, the AI assistant then presents the potential problems to the user. The user has the option to provide feedback (such as “this is a problem” or “this is not a problem”). If the user confirms that one of the potential problems is a problem, then learned-problem-type and problem-detection-prompt are stored in the learned problem database. The system will then run the learned-problem-prompt over the context state in order to detect any problem.

### Adaptive Problem Solving

Adaptive problem solving refers to problem solving in a changing context. However, additional steps are also required. In various embodiments, the AI assistant includes a set of smart prescriptions that it can rely on to solve problems in a particular context. The AI assistant determines whether a prescription should be suggested and, if so, which prescriptions should be suggested.

In various embodiments, the AI assistant suggests a prescription when directly asked to do so (in other words, via a direct invocation). For example, the AI assistant suggests a prescription in response to a user message such as “show me prescriptions.”.

In various embodiments, the AI assistant infers the intent of the user even when not directly prompted. In various embodiments, intent inference takes the form of an interjection into the conversational state when the context is time-sensitive. For example, in response to a message such as “is my shipment late?” the AI assistant answers the question and, if the shipment is late, recognizes that this is a problem. Then the AI assistant finds the cause of the problem (computed as described above) and then finds any smart prescriptions associated with the problem.

If one or more prescriptions are found, these may be shown as “tiles” that the user can optionally select. In various embodiments, prescriptions include fillable fields. The AI assistant attempts to fill out fields from the prompt. If all fields are present, the user will be able to execute the prescription with a single user “execute” input. Otherwise, the prescription may show as a form that prompts the user to fill out the incomplete fields. Once done, the user can execute the prescription.

### Determining Prescriptions

In various embodiments, prescriptions are described to the LLM as “functions” to be invoked. Some LLMs have a “function calling” functionality that results in a callback from the LLM. In various embodiments, each prescription is converted to an llm-ready form and then converted into a vector embedding (prescription to prescription-llm-ready to prescription-embedding). Prescriptions are associated with textual descriptions of the kinds of problems they can solve.

Next, the user message is transformed into a “problem space”: potential-problem=llm(message, candidate-problem-prompt). Then, the potential-problem is converted into embedding space: potential-problem-embedding=llm-embed(potential-problem).

Finally, a similarity check (such as a cosine similarity check) is performed between the potential-problem-embedding and the prescription-embeddings. The prescriptions with the highest similarity (highest cosine scores) are returned provided they exceed a certain (preference-based) setting. The user can choose to execute none or any one of these prescriptions.

If the user executes a prescription, then, in general, the context-real-time-state will be changed. While the prescription is executing, the context is frozen so that the AI assistant does not see “in-between” states. Once the prescription is complete, the AI assistant's cached context is marked as outdated.

On the next message, the context-real-time-state is reloaded, converted to context-real-time-state-llmready and then a real-time prompt is generated as described earlier. Based on this new real-time state, a different set (including a subset, a disjoint set, and/or an overlapping set) of prescriptions may be generated and presented to the user. For example, the AI assistant may first recommend two actions adjusting dates and rescheduling an appointment. After the user selects adjusting dates, then after that action, only the reschedule appointment remains. Of course, in the interim other things may have also changed and a completely different set of prescriptions (or none) may be produced. In various embodiments, the AI assistant receives push notifications from the supply chain contexts describing changes to the underlying state. The AI assistant integrates these changes into subsequent messages using the same real-time state mechanisms described above.

### Learning Preferred Prescriptions

In various embodiments, the AI assistant determines which prescriptions are preferred in various situations by determining an association between solved problems and the execution of the prescriptions. If executing a prescription solves a problem, then the prescription is positively associated with the problem and is more likely to be selected. Additionally, the real-time context is stored along with the positive association as the effectiveness of the prescription may be context-dependent.

However, this does not solve the problem of partial credit when a prescription helps in solving the problem but does not fully resolve it. In various embodiments, the partial credit problem is overcome by allowing the user input to provide positive feedback (such as a “thumbs up” input) if they believe that executing the prescription helped the situation. This acts as a dense reward for positive reinforcement.

In various embodiments, problems are defined differently. In addition to being solved or not, they have an additional normalized solution distance metric associated with them. In various embodiments, the solution distance metric ranges from [0, 1]. When 0, the problem is solved. When 1, the problem is maximally unsolved. When a prescription is executed, the real-time problem distance metric is computed. If the difference between the after-prescription distance and the before-prescription execution is greater than zero (before-prescription-execution-distance−after-prescription-execution-distance>0), then the difference is applied as a numeric reward. Additionally, if the distance is brought to zero, then an extra completion reward is given. For example, the total reward formula is total-reward=distance-reduction-reward+completion-reward.

### Real-Time Visualizations

In various embodiments, the AI assistant provides real-time interactive visualizations. In various embodiments, a visualization is provided in response to a real-time prompt. In various embodiments, the AI assistant infers when a visualization should be provided to the user.

Real-time visualizations are produced in a manner similar to prescriptions. First the visualizations are described textually. Then they are embedded: visualization to visualization-llmready to visualization-embedding. Next, the user's message is converted to “visualization space.” This is done by making a side call to the LLM and appending the visualization qualifier to the user prompt. For example, if the user typed “where is my shipment,” the transformed message may be “an appropriate visualization to the question of ‘where is my shipment.’” For example, message is converted to message-visualization-space and finally to compare(embed(message-visualization-space), visualization-embedding).

Then a similarity test (such as a cosine similarity test) is performed against all the visualization embeddings in this context. The highest ranked visualization that additionally crosses the visualization threshold is also displayed. In various embodiments, visualizations include deep links into the application and context-switching links to other contexts. In various embodiments, the visualizations (and therefore the visualization vector embeddings) change as a function of the underlying state.

In various embodiments, instead of transforming the message into visualization space, the visualization is transformed into message space: List<question>=llm(visualization-to-question-transform-prompt, visualization-llmready). For example, the visualization-to-question-transform-prompt is “generate a list of no more than N questions or messages that a user might directly or indirectly ask where, with a high degree of confidence, the user would benefit from seeing the visualization with description”+visualization-llmready.

### Assistant Permissions

In various embodiments, the AI assistant is associated with a user. Users in the network have read, write, and execute permissions. In various embodiments, the permissions are granular. In various embodiments, the AI assistant inherits the permissions of its governing users. In various embodiments, the user can further restrict (but not expand) the AI assistant's permissions. For example, the user can restrict the AI assistant to have read but not write permissions. In various embodiments, the user can control whether the AI assistant is required to ask for additional permission before performing certain types of actions. For example, the user may stipulate that the AI assistant must ask permission before performing write actions (such as state changing operations).

### Assistant to Assistant Communication

In various embodiments, an assistant may have one or more personas. There is always a default (and required) persona associated with the governing user (governing user persona). Assistant personas allow a general-purpose collaboration between humans and any assistant in the network, not just the AI assistant for which they are the governing user. This mimics how humans themselves directly collaborate to understand things, take actions and solve problems. Secondary personas are used for a user to interact with another user's assistant (in other words, a non-governing user interaction with an assistant). For example, by default, Bob interacts with his default governed assistant and Sally, by default, interacts with her default governed assistant. However, Sally can interact with Bob's governed assistant and Bob can interact with Sally's governed assistant.

### Secondary Personas

In various embodiments, the AI assistant includes a primary persona based on the role and other aspects of the governing user. In various embodiments, secondary personas are also provided by the system. In various embodiments, the governing user can create secondary personas called custom secondary personas.

When an assistant is interacting with a user other than its governing user, it adopts a secondary persona. This persona takes into account the nature and role of the interacting user. In various embodiments, a persona may consider various information about the AI assistant's governing user and the interacting user, such as:
1. The interacting user's role. For example, Bob is a transportation manager, and Sally is a warehouse manager. Bob's assistant has a secondary persona that takes into account that Sally is a warehouse manager.
2. The interacting user's enterprise (such as a company). For example, the other user may be in the same enterprise as Bob or in a different enterprise.
3. The interacting user's relationship to the AI assistant governing user. For example, Bob is the governing user, and Sally is the interacting user. Bob and Sally are part of a reporting hierarchy where Sally is Bob's manager, subordinate or colleague.
4. The interacting user's time zone.
5. The interacting user's experience level (such as novice, or expert).
6. The interacting user's language.

In various embodiments, when an interacting user (in other words, a user other than the governing user) attempts to connect to an assistant, the system maps the user to the appropriate secondary persona. If there are no secondary personas applicable to that user, the user is denied connection.

In various embodiments, the governing user sets up each secondary persona with a whitelist and/or blacklist of users. Additionally, these users can be allowed or disallowed based on other attributes such as their enterprise, role type, relationship to the governing user in the organization, etc. In various embodiments, the governing user only allows access to secondary personas if they have been non-responsive for some duration.

### Permission-Related Customization

In various embodiments, the AI assistant determines a multi-party permissions framework that governs access (such as read, write, and/or act) with every user in the network based on the underlying supply chain network. In various embodiments, a non-governing user (a secondary user) can interact with an assistant. When a secondary user connects to an assistant, the system applies permissions restrictions to the artifacts of the AI assistant. For example, the system applies permissions to the real-time context, the available set of visualizations, the available set of commands, and/or the available set of prescriptions, and creates the base secondary persona for the secondary user. The governing user can choose to further modulate the permissions of this base secondary persona by either loosening the permissions or further tightening them. However, the governing user cannot expand the permissions of the secondary user beyond the permissions of the governing user. For example, a governing user without write permissions cannot give a secondary user write permissions.

For “objects” such as visualizations, commands, prescriptions, etc. the governing user can further tighten or loosen those permissions by selecting or unselecting those objects from the starting point created by the base secondary persona. For the real-time context (which is the form of text), the procedure for modifying permissions differs based on whether the governing user is adding or removing permissions from the secondary user. If the governing user is removing, the governing user provides a removal prompt. The removal prompt can take the form of a summarization prompt or a filtering prompt. In a summarization prompt, the real-time context of the base secondary persona is summarized (thus losing detail). For example, if the real-time context has a set of orders with their prices, the summarization prompt may filter out the prices but only allow aggregate prices to be shown. In a filtering prompt, parts of the base persona real-time context (such as order prices) may be filtered.

In order to loosen the real-time context (looser than the base secondary persona, but no looser than the primary persona), this is done in several steps. Step 1: use a “difference prompt” to extract the information present in the primary persona's real-time context that is not present in the base secondary context. This results in a differential context: differential context=primary persona context−base secondary persona context. Step 2: apply restriction prompts (summarization, filtering) to the differential context to create a restricted differential context. Step 3: the final real-time context of the secondary persona will be the base secondary persona context and the restricted differential context.

### Non-Permission-Related Customization

In various embodiments, the secondary persona can be customized based on various factors including the secondary user's time zone, experience level, and/or language. In various embodiments, the secondary user's time zone is injected into the real-time context. Additionally, the persona can be configured to respond with dates and times in the governing user's time zone, the secondary user's time zone or some universal time zone. In various embodiments, the secondary user's experience level is accounted for by adding to the prompt with instructions to respond at the level of a novice or expert or other gradations. In various embodiments, the secondary user's language is accounted for by adding instructions in the prompt to respond to the user in their specified language. In various embodiments, the language can be detected from the user's questions. In various embodiments, the persona can be named. For example, the persona is named “Bob—Peer assistant” or “warehouse manager at Warehouse 7—role assistant.”

When a secondary user is interacting with an assistant via a secondary persona, the secondary user may request a human escalation (to the governing user). This can be performed in several ways including but not limited to emailing the governing user or using the built-in network chat. In various embodiments, the AI assistant can monitor the chat to auto-escalate. Auto-escalation is performed by passing the chat transcript through a separate escalation prompt which classifies the chat into needing an escalation or not.

### User Experience

In various embodiments, the user experience is organized in various ways. For example, the AI assistant displays various users and/or personas that are available for interaction. For example, the user interface includes a list of available users and/or assistants such as: i) the user's assistant, ii) another user (a peer named “Sally”), iii) a peer user's assistant (Sally's assistant), iv) a peer assistant from another enterprise, v) one or more role-based assistants (such as “Warehouse Manager—Warehouse 1” or “Transportation Manager—Southeast Region.”)

In various embodiments, the user interface displays all assistants as “users” in the chat interface. For example, selecting “Sally” would be used to chat with human Sally, whereas selecting “Sally (Peer assistant)” starts an interaction with her assistant (via some secondary persona she set up on her assistant). In various embodiments, role assistants may be available without an indication of the governing user.

In various embodiments, role assistants from other enterprises may be displayed and interacted with. In various embodiments, an assistant can communicate with another assistant (as defined by a permissions framework). In various embodiments, assistants retrieve requests from other assistants. When an assistant receives a request, the AI assistant determines whether to accept the request. In various embodiments, the conversation can be downgraded to a chat without executable prescriptions and/or automatic context switching to allow the other party to participate through conventional chat clients such as Microsoft Teams, Slack, WhatsApp, text messaging, email etc.

Requests can be of two types, either session requests or single message requests. If the AI assistant accepts the request, the AI assistant determines which context to use based on analyzing the request from the other assistant. All assistant-to-assistant communication is done in natural language, which enables human-based auditing. Once an assistant has accepted the request, the AI assistant responds in a single message context where the real-time-prompt=context-real-time-state+other-assistant-message. Otherwise, the AI assistant applies the full real-time-prompt with recontextualization or redaction as described above.

### Degree-of-Synthesis Modulation

One important capability of the AI assistant is to synthesize the context-real-time-state with the general knowledge of the LLM. However, the degree to which this information is synthesized has important implications. The more synthesis that is permitted, the more “creative” the AI assistant will be. This is useful in some contexts and less desirable in others.

In various embodiments, the AI assistant supports several levels of synthesis including strict, neutral, expansive, creative. Other arrangements are possible too. By default, the AI assistant is in the strict mode. However, the user can modify the synthesis-level. This can be done at the level of the entire context (thread) or can be done at the message level. The degree of synthesis is governed by the synthesis modulation part of the prompt. This essentially tells the LLM how far it should incorporate knowledge outside of the user-specified prompt.

In various embodiments, not only is the synthesis modulator applied to the prompt, but also the similarity thresholds (such as cosine similarity thresholds) are relaxed as the synthesis modulation is relaxed. This tends to cause more prescriptions and visualizations to be displayed.

### Scenario Management

In various embodiments, a governing user or secondary user wishes to engage with the AI assistant in a scenario mode. In this case, the AI assistant creates a scenario chain in the supply chain network and generates a real-time context specific to this scenario chain. All commands, prescriptions and visualizations are directed towards the scenario chain. This allows users to easily explore scenarios and answer “what if” questions.

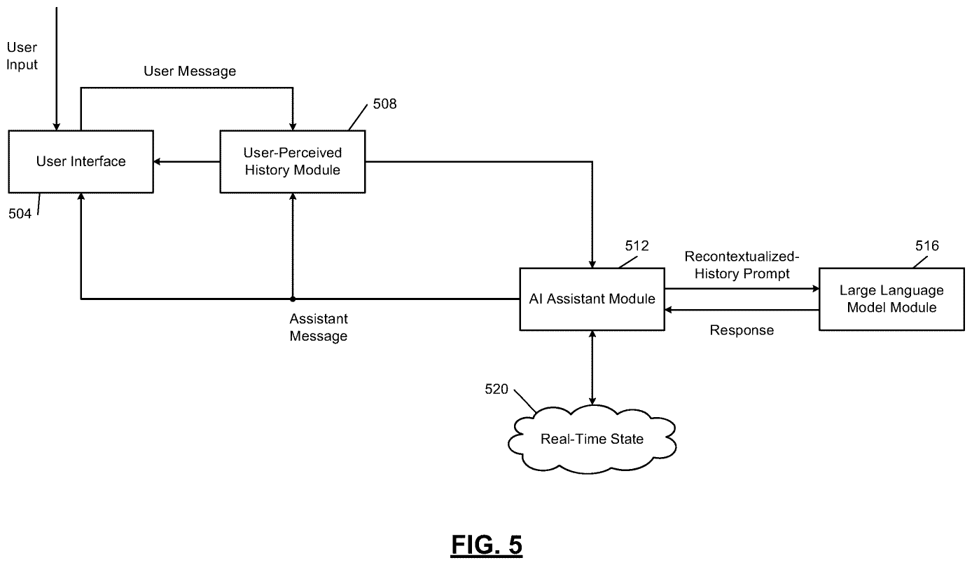

FIG. 5 is a block diagram of an example approach for processing messages and real-time context. User interface 504 receives user input, which is transmitted as a user message and added to the user-perceived history at user-perceived history module 508. The user message is analyzed by AI assistant module 512 (for example, to redact or recontextualize) and an AI assistant prompt is sent to large language model module 516, which generates a response and transmits it to AI assistant module 512. AI assistant module 512 interacts with real-time state 520 to generate the prompt based on the user message. In various embodiments, real-time state 520 is limited by user permissions and/or the thread associated with the user message.

### Example User Interfaces

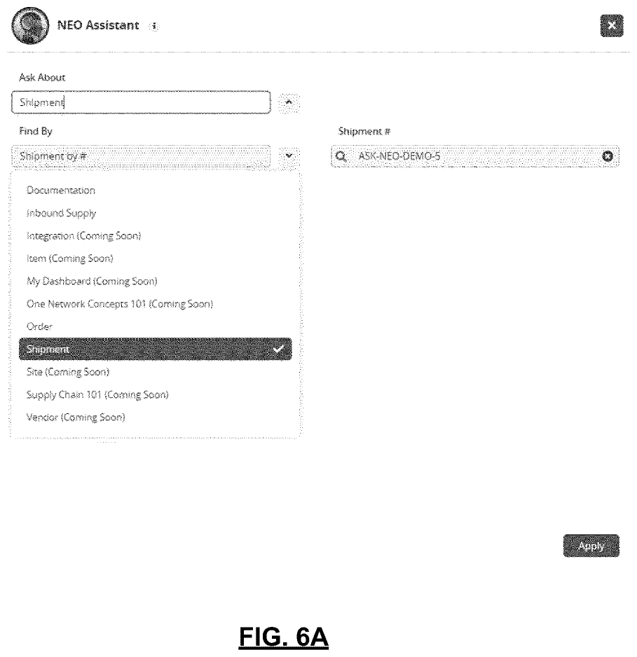

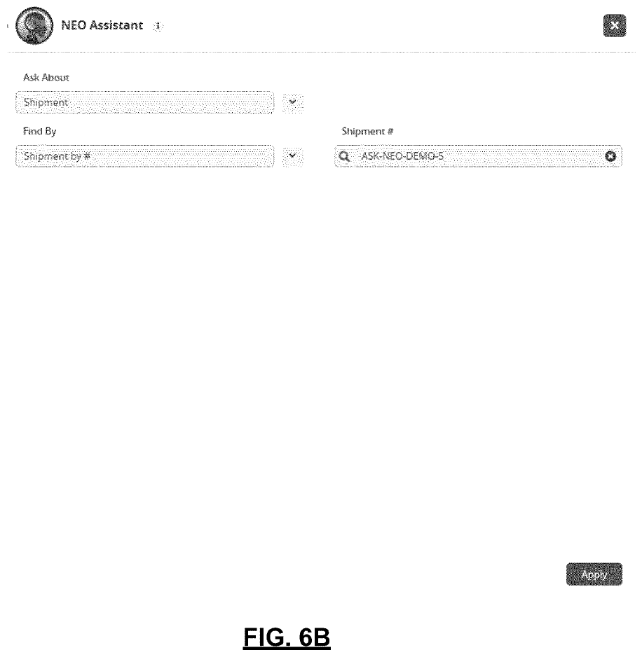

FIG. 6A is an example user interface for interacting with an AI-enabled assistant by selecting a topic (such as a shipment). In FIG. 6B, a user has selected a user interface element to find a shipment based on a shipment number: in this case, “ASK-NEO-DEMO-5.”

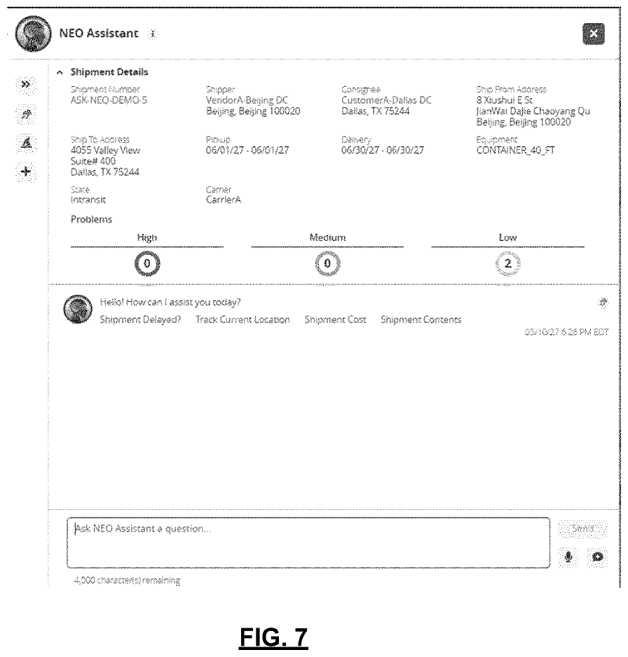

FIGS. 7-19 are example user interfaces for interacting with an AI-enabled assistant with various functionalities. In FIG. 7, the AI-enabled assistant has started a new thread about the requested shipment (“ASK-NEO-DEMO-5”). The new thread shows a context header, which includes information about the selected context. Additionally, the user interface indicates problems related to the shipment (for example, there are two “Low” problems).

In various embodiments, the user interface includes various sample questions and prompts offered to the user for various tasks. For example, prompts may include “shipment delayed,” “track current location,” “shipment cost,” or “shipment contents.” Additional questions may include “can you provide the delivery timeline for my shipment,” “can you provide the proof of delivery for my shipment,” “can you recommend any other carriers for my shipment,” “can you track the customs clearance status of my international shipment,” “has my package been handed over to the local courier for final delivery,” “how can I save on shipment costs,” “is my shipment insured,” “what are some ways to reduce the cost of my shipment,” “what is the current location of my shipment,” “what is the estimated arrival time of my shipment,” “what is the pro number for my shipment,” “what is the weight of my package,” “where did the delay occur in the shipment process,” etc.

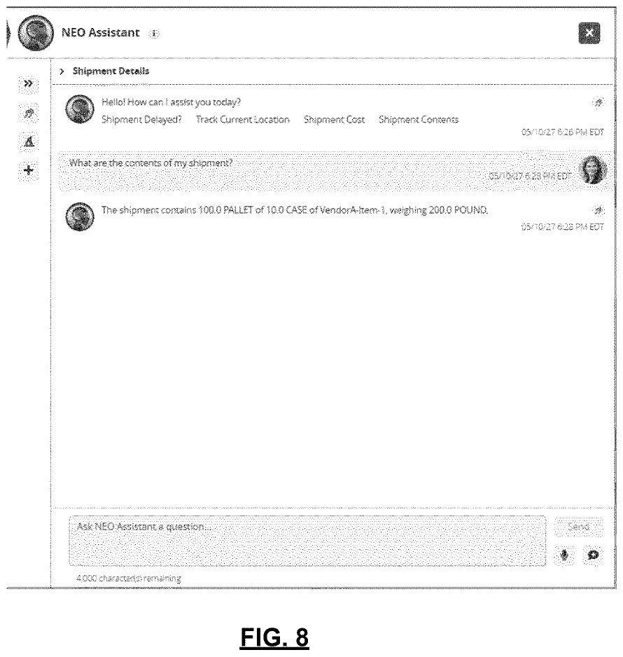

In FIG. 8, the user interface has been updated to display a response to a quick question. In this case, the quick question is “what are the contents of my shipment,” which may have been triggered by selecting “shipment contents” above. The user interface is transformed to display the contents.

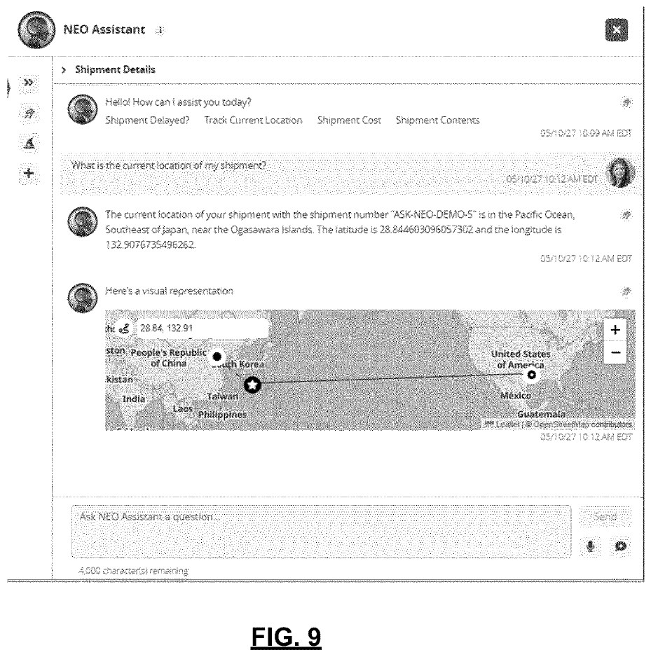

In FIG. 9, the user interface updates in response to an inquiry about the location of a shipment. The user interface displays a text response describing the location and a map-based visual representation of the shipment location. In various embodiments, the visual representation includes a representation of previous locations and the current location.

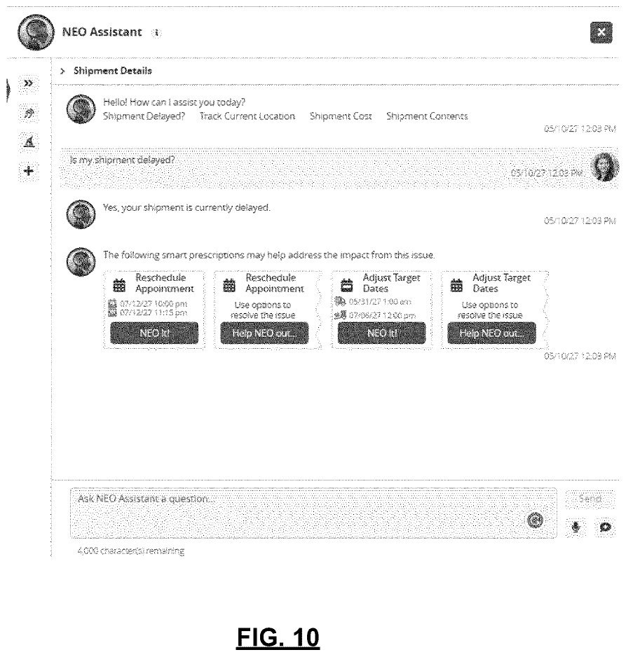

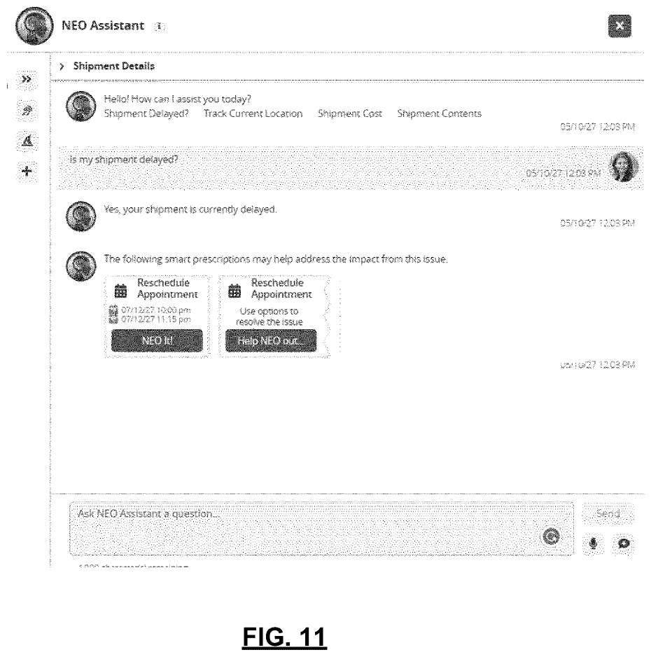

In FIG. 10, the user asks the AI-enabled assistant if the shipment is delayed, such as by selecting “shipment delayed?” above. The user interface updates with the response of the AI-enabled assistant (“yes”). The AI-enabled assistant also generates several prescriptions for the delayed shipment that are displayed in the user interface. In this case, the prescriptions include options to reschedule the shipment and/or adjust the target date, which can be performed from the user interface. In FIG. 11, the user has selected to adjust the target date as described in FIG. 10, the user interface updates to display updated prescriptions, which now only include a “Reschedule Appointment” prescription because the target date has already been adjusted.

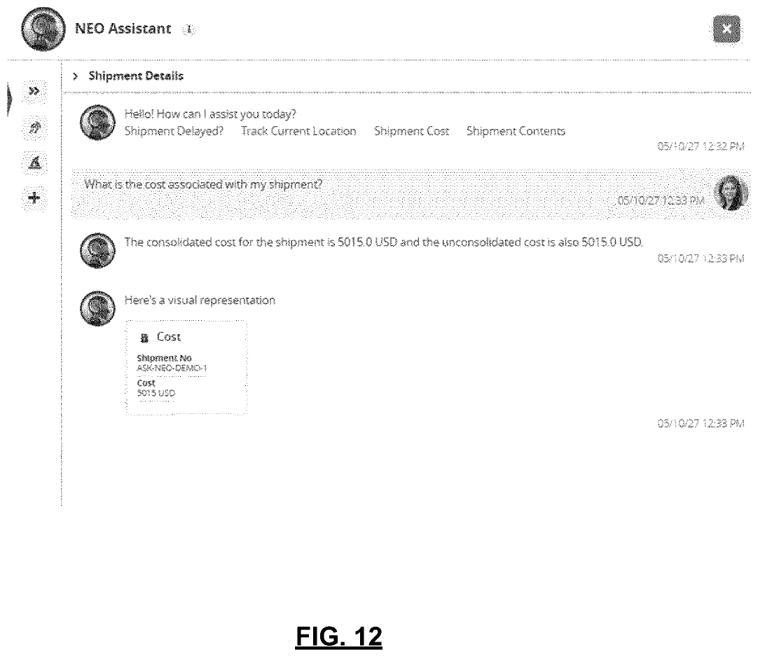

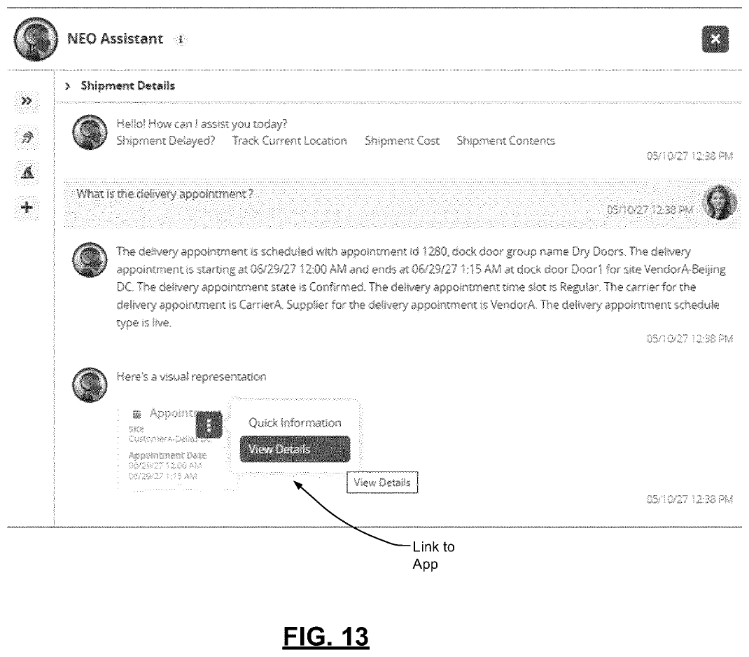

In FIG. 12, in response to an inquiry about the cost of a shipment, the AI-enabled assistant generates a cost visualization that is displayed in the user interface. In FIG. 13, in response to an inquiry about a delivery appointment, the AI-enabled assistant generates a list of appointment details and an appointment visualization. In various embodiments, the visualization includes a link to another application such as a database with appointment details.

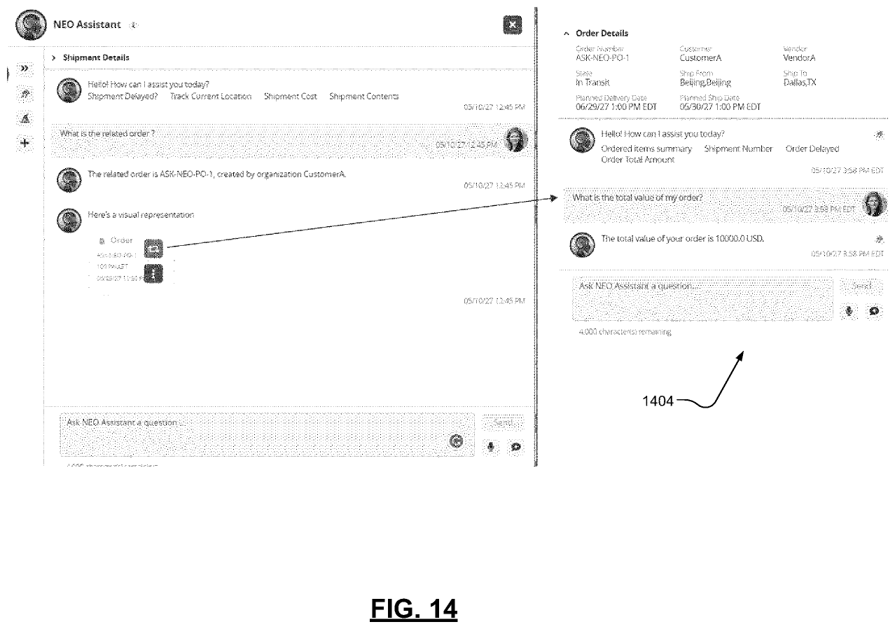

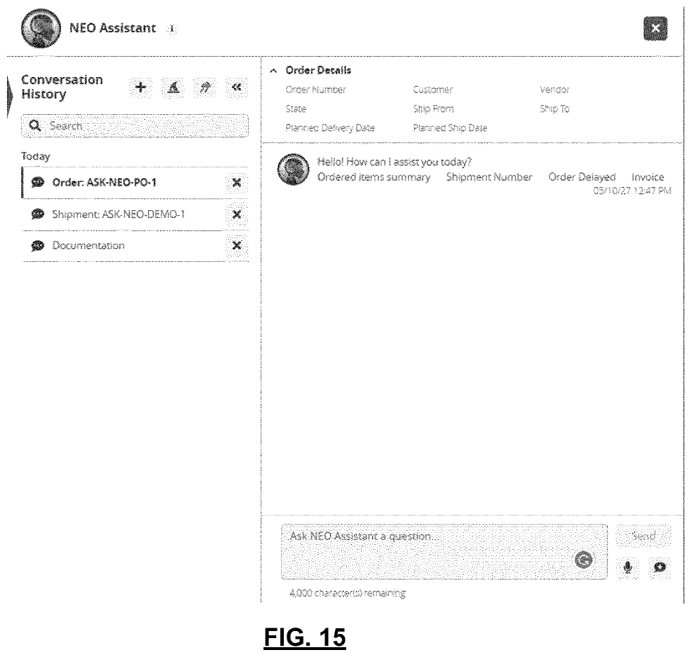

In FIG. 14, in response to a user inquiry about a related order, the user interface displays the AI-enabled assistant's response, which includes a text answer that lists the related order, and a visualization of the order with a link to another context thread 1404 in which the related order is discussed. In FIG. 15, the user interface updates to display a new conversation after the user selects the link to the other context thread.

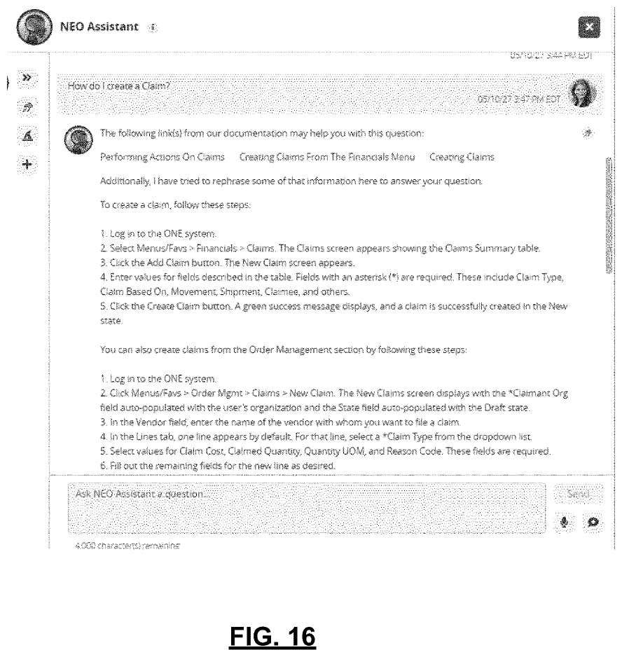

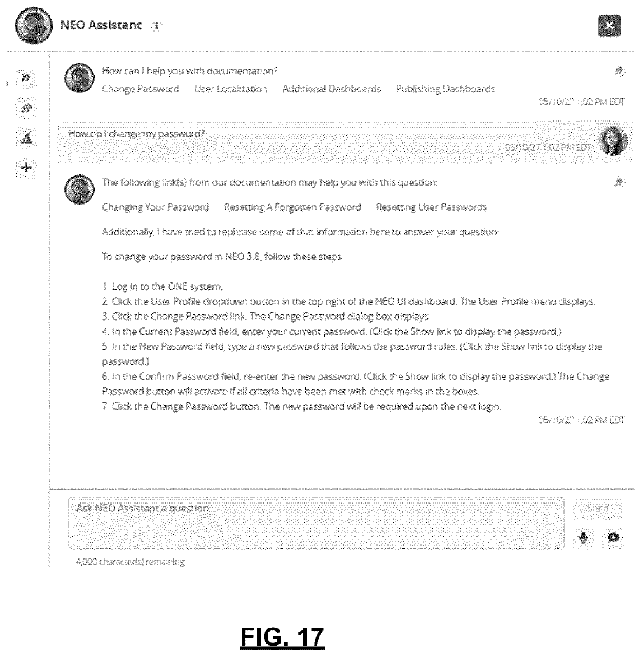

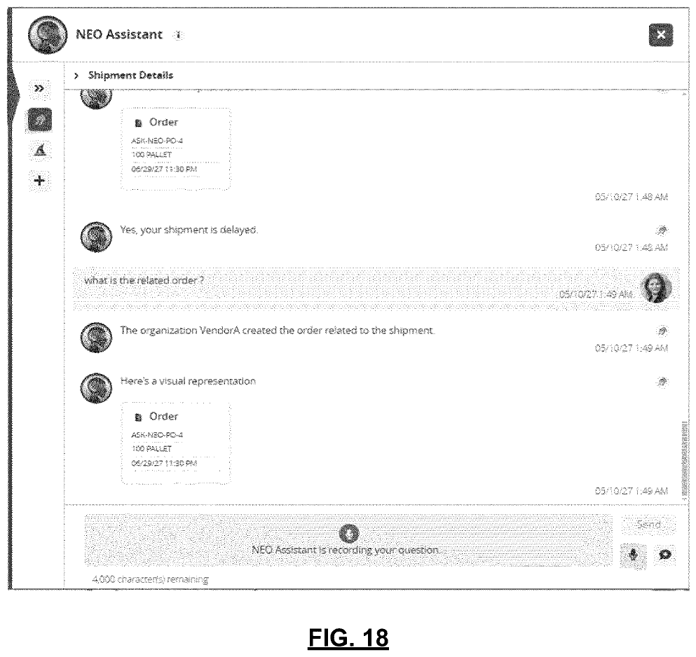

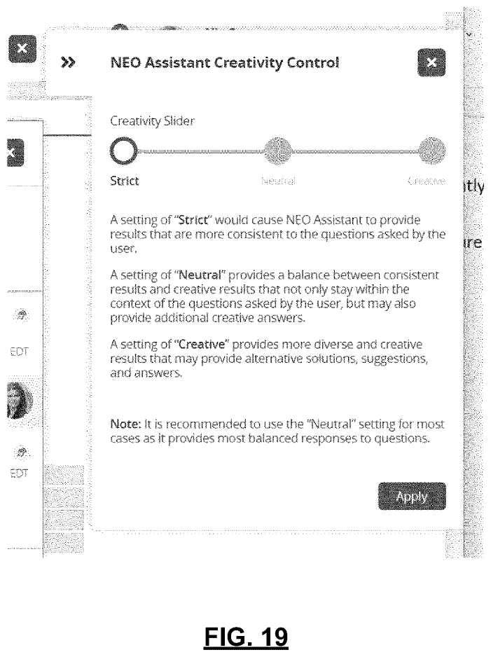

In FIG. 16, the user interface includes a generalized inquiry mode and displays the AI-enabled assistant's response to an inquiry about creating a claim. In FIG. 17, the user interface displays the AI-enabled assistant's response to an inquiry about resetting a password. FIG. 18 is an example user interface including text-to-speech and speech-to-text elements. FIG. 19 is an example user interface for modifying the creativity control of the AI-enabled assistant. For example, in strict mode, the AI-enabled assistant strictly adheres to the current context. In other modes, the AI-enabled assistant increasingly synthesizes world knowledge and is more likely to interject with prescriptions.

### Real-Time Context Management at Scale

Many LLMs have a maximum token limit (such as 100,000 tokens) that is much smaller than the real-time context (for example, several million tokens). In such situations, retrieval augmented generation (“RAG”) is used to determine which context is necessary for determining an answer to a query. For example, rather than submitting the entire context dataset to an LLM, a function is passed to the LLM, which can be called to retrieve context that is necessary to answer a query. In various embodiments, cosine similarity is used to compare a query and context. In various embodiments, context that meets a similarity threshold is submitted to the LLM.

In various embodiments, the real-time context is so large that even the number of functions exceeds the LLM token limit and RAG is performed on the functions. In various embodiments, each function includes a set of sample queries that the data returned by the function is able to answer.

In various embodiments, cosine similarity is used to compare a query with each sample query individually. In various embodiments, cosine similarity is used to compare a query with the entire set of sample queries (for example, a concatenated string including each sample query). In various embodiments, cosine similarity is used to compare a query with both i) the entire set of sample queries and with ii) each sample query individually. In various embodiments, functions that are associated with sample queries that meet a similarity metric threshold are added to a candidate list which is submitted to the LLM. In various embodiments, the similarity metric threshold varies depending on whether the sample queries are compared individually, as a set, or a combination of the two. For example, the similarity metric threshold may be higher for a single sample query than the similarity metric threshold for a set of sample queries.

Once a set of candidate functions has been determined, they are passed to the LLM, which determines which functions of the candidate functions to call to answer the query. In various embodiments, the real-time context is stored as a graph, which is not easily understandable by the LLM. In various embodiments, the executed functions traverse the graph and locate sub-graphs that contain real-time context relevant to the query. The function then translates the sub-graph into narrative plain text that is easily interpreted by the LLM. In various embodiments, the sub-graph is translated into multiple plain-text descriptions, where each description is from a different viewpoint (or filter). For example, a sub-graph describing all deliveries associated with Dallas, Texas could be translated into a plain-text description of deliveries leaving Dallas, arriving in Dallas, carried by Carrier A, carried by Carrier B, late deliveries, early deliveries, all deliveries in chronological order, deliveries from China, etc. In various embodiments, viewpoints are automatically determined by analyzing the data fields and/or relationships of the sub-graph.

### Example Flowchart of Real-Time Context Management at Scale

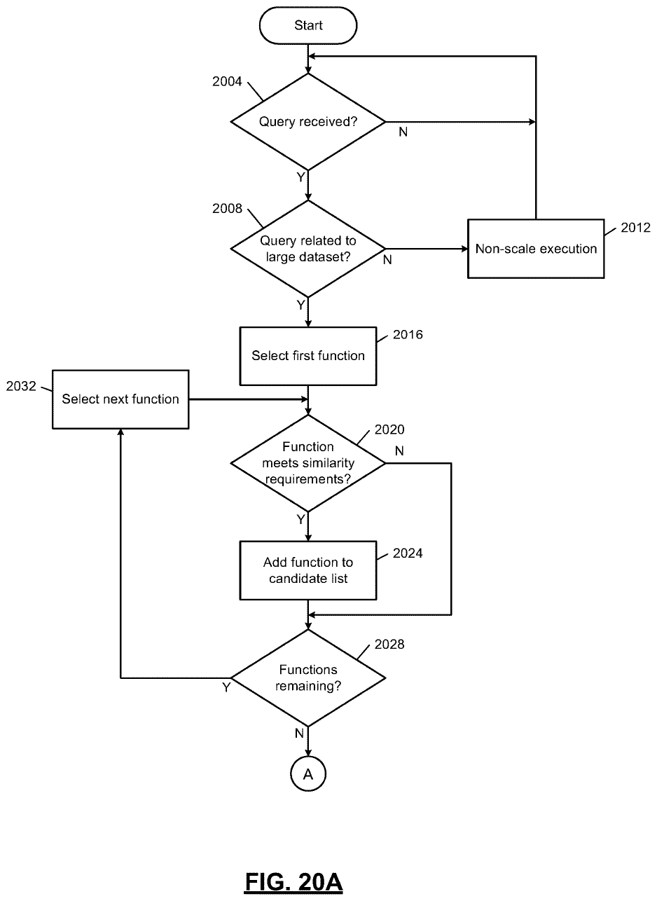

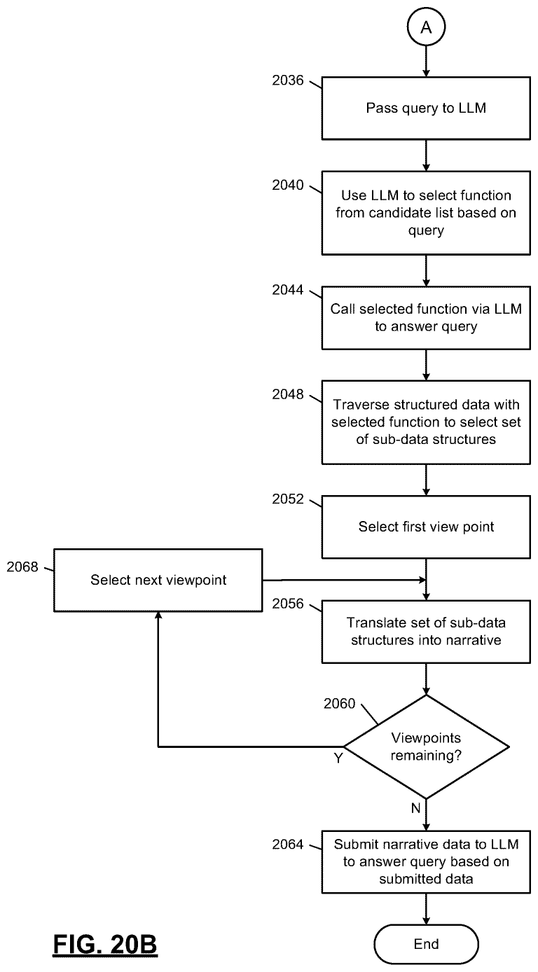

FIGS. 20A-20B are a flowchart of an example method for creating LLM-understandable context based on large real-time datasets. Control begins at 2004 and determines whether a query has been received. If a query has not been received, control remains at 2004. If a query has been received, control transfers to 2008. At 2008, control determines whether the query is related to a large dataset (for example, a context dataset that exceeds an LLM token limit). If the query is not related to a large dataset, control transfers to 2012 and analyzes the query without the steps described below (for example, by submitting the real-time context to the LLM as described above).

If the query is related to a large dataset, control transfers to 2016. At 2016, a first function is selected. Next, at 2020, control determines whether the selected function meets similarity requirements (for example, whether sample queries associated with the selected function meet a cosine similarity threshold when compared to the received query). If the function does not meet the similarity requirements, control transfers to 2028. If the function meets the similarity requirements, control transfers to 2024 and adds the function to a candidate list of down-selected functions.

At 2028, control determines whether additional functions remain. If one or more functions remain, control transfers to 2032 to select a new function and then returns to 2020. If no functions remain, control transfers to 2036. At 2036, the received query is passed to an LLM. At 2040, the LLM determines which function of the candidate list to use to answer the query. At 2044, the LLM calls the selected function to answer the query. At 2048, the selected function traverses a structured graph to select a set of sub-data structures.

At 2052, control selects a first viewpoint. At 2056, control translates the set of sub-data structures into a narrative text summary of the sub-data structures based on the selected viewpoint. At 2060, control determines whether applicable viewpoints remain. If viewpoints remain, control transfers to 2068 and selects the next viewpoint. Control then returns to 2056. If no viewpoints remain, control transfers to 2064 and the function returns the narrative text summaries from the various viewpoints to the LLM, which uses the narrative text to answer the query.

### Example System of Real-Time Context Management at Scale

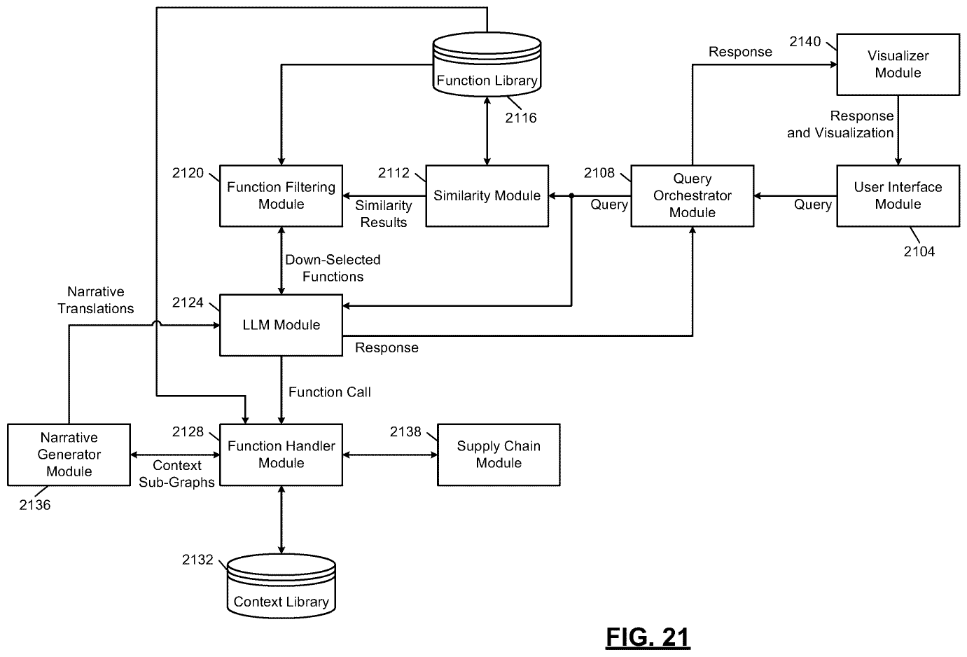

FIG. 21 is a functional block diagram of an example system for creating LLM-understandable context based on large real-time datasets. User interface module 2104 receives user queries and/or instructions, transmits user queries and/or instructions, and displays responses (generated by LLM module 2124) and visualizations (generated by visualizer module 2140) based on the responses.

Query orchestrator module 2108 receives queries and responses. In various embodiments, query orchestrator module 2108 determines whether the query scope requires context that exceeds a token limit of LLM module 2124. In various embodiments, query orchestrator module 2108 coordinates the execution of similarity module 2112, visualizer module 2140, LLM module 2124, and/or other modules. Query orchestrator module 2108 transmits the query to similarity module 2112.

Similarity module 2112 compares (for example, via cosine similarity) the query with sample queries associated with functions stored in function library 2116. Similarity module 2112 generates similarity results including similarity metrics of individual sample queries, a concatenated set of sample queries, or both. Function filtering module 2120 determines which functions meet the similarity metric threshold and down-selects the functions stored in the function library to a candidate set of functions. The set of candidate functions is transmitted to LLM module 2124.

In various embodiments, function filtering module 2120 uses LLM module 2124 to generate a set of keywords associated with the query which can be used to filter functions stored in function library 2116.

LLM module 2124 determines which of the candidate functions will answer the query received by query orchestrator module 2108 and executes a function call of the selected function. The function call is handled by function handler module 2128. The executed function traverses a set of data graphs stored in context library 2132 and selects a set of sub-graphs. In various embodiments, the traversal and sub-graphs are predefined by the function. The selected set of sub-graphs is transmitted to narrative generator module 2136, which creates a plain-text summary of the sub-graphs from various applicable viewpoints. In various embodiments, the plain-text summary is generated using the selected function. In various embodiments, function handler module 2128 interacts with supply chain module 2138 to effectuate changes such as updating routes or appointments.

LLM module 2124 uses the plain-text summaries to answer the query and generate a response, which is then transmitted to query orchestrator module 2108. Visualizer module 2140 generates visualizations if applicable. In various embodiments, query orchestrator module 2108 interacts with one or more modules to modify data. For example, query orchestrator module 2108 coordinates the update of a schedule or route based on instructions received by user interface module 2104 and using functions stored in function library 2116.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Numerical terms, such as “first,” “second,” and “third,” may be used in the disclosure and claims as unique labels: they are not used to imply a sequence or order unless the context clearly indicates otherwise. In other words, a “second” element could be relabeled as a “first” element without departing from the principles of the present disclosure. Further, the presence of a “second” element does not imply or require the presence of a “first” element. Similarly, the presence of a “first” element does not imply or require the presence of a “second” element.

Unless the context clearly indicates otherwise, the singular articles “a,” “an,” and “the” before a noun do not restrict the noun to a single instance. The verbs “comprise,” “include,” and “have” are inclusive and therefore specify the presence of elements without excluding the presence of one or more additional elements.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “coupled,” and “engaged.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

The term “set” generally means a grouping of one or more elements. The elements of a set do not necessarily need to have any characteristics in common or otherwise belong together. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgments of, the information to element A.

In this application, including the definitions below, the term “module” can be replaced with the term “controller” or the term “circuit.” In this application, the term “controller” can be replaced with the term “module.” The term “module” may refer to, be part of, or include processor hardware (shared, dedicated, or group) that executes code coupled with memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

1. A system comprising:
memory hardware storing a defined data structure that specifies:
a plurality of groups that is each associated with a respective set of users,
schedule data, and
relationship data that describes relationships between the plurality of groups, each respective set of users, and the schedule data;
a context module configured to determine a default context associated with a first user, wherein:
the first user is included in a respective set of users of a first group of the plurality of groups, and
the default context is associated with a subset of the schedule data, a subset of the plurality of groups, and the respective set of users;
a user interface module configured to:
receive and transmit user input, and
transmit data to the first user;
a machine learning model interface module configured to:
generate prompts for a machine learning module based on user input from the user interface module, and
receive textual output from the machine learning module;
a real-time state module configured to:
determine, via a machine learning model, a first real-time state of the defined data structure, wherein the first real-time state is based on the default context, and
determine, via the machine learning model, whether an issue exists in the first real-time state of the defined data structure;
an action generation module configured to:
in response to a determination that an issue exists in the first real-time state of the defined data structure, generate, via the machine learning model, a set of solutions for the issue, wherein the set of solutions is based on the first real-time state of the defined data structure, and
in response to a user input associated with a selection of a solution of the set of solutions, execute the selected solution,
wherein the real-time state module is configured to, in response to the execution of the selected solution, replace the first real-time state of the defined data structure with a second real-time state of the defined data structure based on the default context and the selected solution; and
an inference module configured to generate, via the machine learning model, a secondary response to user input based on the first real-time state or the second real-time state.

2. The system of claim 1, wherein:
the subset of the schedule data, the subset of the plurality of groups, and the respective set of users is selected based on the relationship data, and
the default context is based on one or more secondary sets of users associated with the subset of the plurality of groups.

3. The system of claim 1, wherein:
inferring whether to generate the secondary response is based on a secondary prompt to the machine learning model,
the secondary prompt is based on the user input,
the secondary response includes a visualization of a portion of the first real-time state or the second real-time state, and
replacing the first real-time state includes marking the first real-time state of the defined data structure as historical data.

4. The system of claim 1, further comprising a prompt generation module configured to:
generate a set of prompts based on the default context, wherein the set of prompts is based on:
a set of previous user inputs from the first user,
a set of inputs from a set of secondary users, and
a set of responses with a high effectiveness score.

5. The system of claim 1, wherein:
the context module is configured to determine a set of contexts associated with the first user,
the default context is included in the set of contexts, and
the user interface module is configured to:
receive a first user input, and
in response to receiving the first user input, generate a link to use a second context from the set of contexts.

6. The system of claim 1 further comprising:
a function library configured to store a set of functions, wherein a first function of the set of functions includes a set of sample queries;
a similarity module configured to:
in response to receiving a set of queries, determine a similarity metric based on a comparison of the set of queries and the set of sample queries; and
in response to a determination that the similarity metric meets a similarity threshold, add the first function to a set of down-selected functions;
a large language model (LLM) module configured to:
determine, using an LLM, one or more functions of the set of down-selected functions to execute;
receive a set of function responses corresponding to the one or more functions of the set of down-selected functions; and
determine, using the LLM, a response to the set of queries based on the set of function responses; and
a function handler module configured to execute the one or more functions of the set of down-selected functions, wherein:
the one or more functions traverse a data graph,
the one or more functions select a set of sub-graphs of the data graph,
the one or more functions translate the set of sub-graphs into the set of function responses,
translating the set of sub-graphs into the set of function responses includes generating a set of narrative text describing a set of relationships of the set of sub-graphs, and
the set of narrative text includes a set of viewpoints.

7. The system of claim 6, wherein:
a first viewpoint of the set of viewpoints includes a subset of the set of narrative text based on a first filter of a set of filters,
the set of sample queries includes queries that can be answered with the set of sub-graphs selected by the first function,
the comparison of the set of queries and the set of sample queries includes performing cosine similarity of the set of queries and at least one sample query of the set of sample queries,
the set of narrative text includes a set of plain-text strings that describes the set of sub-graphs, and
the LLM module is configured to communicate with the LLM via an application programming interface (API).

8. The system of claim 7, wherein the set of filters includes at least one of:
a filter associated with a destination location,
a filter associated with a source location,
a filter associated with a carrier,
a filter associated with a time,
a filter associated with a region,
a filter associated with a transportation type, or
a filter associated with a delivery status.

9. The system of claim 6, further comprising a query orchestrator module configured to:
determine whether a context associated with the set of queries exceeds a token limit associated with the LLM; and
in response to a determination that the context exceeds the token limit:
transmit a query to the similarity module to determine the set of down-selected functions, and
transmit the query to the LLM module.

10. The system of claim 6, wherein the similarity threshold is determined based on at least one of:
whether one of the set of sample queries is used to determine the similarity metric, or
whether the set of sample queries is concatenated into a single string and used to determine the similarity metric.

11. A method comprising:
determining a default context associated with a first user, wherein:
a defined data structure specifies:
a plurality of groups that is each associated with a respective set of users,
schedule data, and
relationship data that describes relationships between the plurality of groups, each respective set of users, and the schedule data;
the first user is included in a respective set of users of a first group of the plurality of groups, and
the default context is associated with a subset of the schedule data, a subset of the plurality of groups, and the respective set of users;
receiving and transmitting user input;
transmitting data to the first user;
generating prompts for a machine learning module based on user input;
receiving textual output from the machine learning module;
determining, via a machine learning model, a first real-time state of the defined data structure, wherein the first real-time state is based on the default context;
determining, via the machine learning model, whether an issue exists in the first real-time state of the defined data structure;
in response to a determination that an issue exists in the first real-time state of the defined data structure, generating, via the machine learning model, a set of solutions for the issue, wherein the set of solutions is based on the first real-time state of the defined data structure;
in response to a user input associated with a selection of a solution of the set of solutions, executing the selected solution,
in response to the execution of the selected solution, replacing the first real-time state of the defined data structure with a second real-time state of the defined data structure based on the default context and the selected solution; and
generating, via the machine learning model, a secondary response to user input based on the first real-time state or the second real-time state.

12. The method of claim 11, wherein:
inferring whether to generate the secondary response is based on a secondary prompt to the machine learning model,
the secondary prompt is based on the user input,
the secondary response includes a visualization of a portion of the first real-time state or the second real-time state, and
replacing the first real-time state includes marking the first real-time state of the defined data structure as historical data.

13. The method of claim 11, further comprising:
determining a set of contexts associated with the first user, wherein the default context is included in the set of contexts,
receiving a first user input, and
in response to receiving the first user input, generating a link to use a second context from the set of contexts.

14. The method of claim 11, further comprising:
storing a set of functions, wherein a first function of the set of functions includes a set of sample queries;
in response to receiving a set of queries, determining a similarity metric based on a comparison of the set of queries and the set of sample queries;
in response to a determination that the similarity metric meets a similarity threshold, adding the first function to a set of down-selected functions;
determining, using an LLM, one or more functions of the set of down-selected functions to execute;
receiving a set of function responses corresponding to the one or more functions of the set of down-selected functions;
determining, using the LLM, a response to the set of queries based on the set of function responses; and
executing the one or more functions of the set of down-selected functions, wherein:
the one or more functions traverse a data graph,
the one or more functions select a set of sub-graphs of the data graph,
the one or more functions translate the set of sub-graphs into the set of function responses,
translating the set of sub-graphs into the set of function responses includes generating a set of narrative text describing a set of relationships of the set of sub-graphs, and
the set of narrative text includes a set of viewpoints.

15. The method of claim 14, wherein:
a first viewpoint of the set of viewpoints includes a subset of the set of narrative text based on a first filter of a set of filters,
the set of sample queries includes queries that can be answered with the set of sub-graphs selected by the first function,
the comparison of the set of queries and the set of sample queries includes performing cosine similarity of the set of queries and at least one sample query of the set of sample queries, and
the set of narrative text includes a set of plain-text strings that describes the set of sub-graphs.

16. A non-transitory computer-readable storage medium comprising processor-executable instructions, the instructions including:
determining a default context associated with a first user, wherein:
a defined data structure specifies:
a plurality of groups that is each associated with a respective set of users,
schedule data, and
relationship data that describes relationships between the plurality of groups, each respective set of users, and the schedule data;
the first user is included in a respective set of users of a first group of the plurality of groups, and
the default context is associated with a subset of the schedule data, a subset of the plurality of groups, and the respective set of users;
receiving and transmitting user input;
transmitting data to the first user;
generating prompts for a machine learning module based on user input;
receiving textual output from the machine learning module;
determining, via a machine learning model, a first real-time state of the defined data structure, wherein the first real-time state is based on the default context;
determining, via the machine learning model, whether an issue exists in the first real-time state of the defined data structure;
in response to a determination that an issue exists in the first real-time state of the defined data structure, generating, via the machine learning model, a set of solutions for the issue, wherein the set of solutions is based on the first real-time state of the defined data structure;
in response to a user input associated with a selection of a solution of the set of solutions, executing the selected solution,
in response to the execution of the selected solution, replacing the first real-time state of the defined data structure with a second real-time state of the defined data structure based on the default context and the selected solution; and
generating, via the machine learning model, a secondary response to user input based on the first real-time state or the second real-time state.

17. The non-transitory computer-readable storage medium of claim 16, wherein:
inferring whether to generate the secondary response is based on a secondary prompt to the machine learning model,
the secondary prompt is based on the user input,
the secondary response includes a visualization of a portion of the first real-time state or the second real-time state, and
replacing the first real-time state includes marking the first real-time state of the defined data structure as historical data.

18. The non-transitory computer-readable storage medium of claim 16, wherein the instructions include:
determining a set of contexts associated with the first user, wherein the default context is included in the set of contexts,
receiving a first user input, and
in response to receiving the first user input, generating a link to use a second context from the set of contexts.

19. The non-transitory computer-readable storage medium of claim 16, wherein the instructions include:
storing a set of functions, wherein a first function of the set of functions includes a set of sample queries;
in response to receiving a set of queries, determining a similarity metric based on a comparison of the set of queries and the set of sample queries;
in response to a determination that the similarity metric meets a similarity threshold, adding the first function to a set of down-selected functions;
determining, using an LLM, one or more functions of the set of down-selected functions to execute;
receiving a set of function responses corresponding to the one or more functions of the set of down-selected functions;
determining, using the LLM, a response to the set of queries based on the set of function responses; and
executing the one or more functions of the set of down-selected functions, wherein:
the one or more functions traverse a data graph,
the one or more functions select a set of sub-graphs of the data graph,
the one or more functions translate the set of sub-graphs into the set of function responses,
translating the set of sub-graphs into the set of function responses includes generating a set of narrative text describing a set of relationships of the set of sub-graphs, and
the set of narrative text includes a set of viewpoints.

20. The non-transitory computer-readable storage medium of claim 19, wherein:
a first viewpoint of the set of viewpoints includes a subset of the set of narrative text based on a first filter of a set of filters,
the set of sample queries includes queries that can be answered with the set of sub-graphs selected by the first function,
the comparison of the set of queries and the set of sample queries includes performing cosine similarity of the set of queries and at least one sample query of the set of sample queries, and
the set of narrative text includes a set of plain-text strings that describes the set of sub-graphs.
